(19) United States
(12) Patent Application Publication
(10) Pub. No.: US 2002/0195444 A1
(43) Pub. Date: Dec. 26, 2002

(54) Thick film heater integrated with low temperature components and method of making the same

(76) Inventors: Hongy Lin, Chesterfield, MO (US); Thomas M. Laskowski, Pacific, MO (US); Louis P. Steinhauser, St. Louis, MO (US)

Correspondence Address: BLUMENFELD, KAPLAN & SANDWEISS, P.C., 168 NORTH MERAMEC, 4TH FLOOR, CLAYTON, MO, 63105-3763, US

(21) Appl. No.: 09/681,891

(22) Filed: Jun. 21, 2001

(51) Int. Cl. H05B 3/22

(52) U.S. Cl. 219/543; 338/308; 29/620

(57) ABSTRACT

A thick film heater is shown wherein the thick film resistive circuit, as the heating element, is applied directly to a target object to be heated for very low temperature applications. The thick film used is polymer-based (preferably epoxy). The thick film resistive circuit is applied using conventional means. However, it is cured at higher temperatures and longer cycles than conventional thick film circuits, and preferably in multiple stages.

### BACKGROUND OF INVENTION

1. Field of the Invention

The present invention relates to thick film heaters comprising a heating element of electrically resistive thick film circuitry, and more specifically to a heater applied directly to a target object.

2. Description of Prior Art

It is often necessary to heat certain objects (“the target object”) for a variety of applications, and it has long been known to accomplish this task with electrical heaters using heating element of an electrically resistive circuit to generate heat. In more recent years it has been known to use heaters with a heating element made of a thick film circuit. It has also been known to use flexible heaters made of two layers of silicon rubber with a wire circuit heating element disposed between the layers. The flexible heater is then placed around the target object. In other applications cartridge heaters comprising a cylindrical metal sheath with a wound heating element disposed therein, are inserted into bores drilled in the target object.

All of these prior heating techniques have serious drawbacks and limitations however. This is particularly true in applications where the target object is used in very low temperatures, for instance 77K, which is the temperature of liquid nitrogen.

For instance, in a cryogenic pump a cartridge heater is conventionally used to heat absorbent for trapping gas molecules and to regulate its temperature to assure proper operation of the pump. There are several limitations to this heating method. Because of the bulk of the heater, there is some distance between the heater and the absorbent to be heated. This longer heat transfer path means longer heat up times, which is compounded by the large thermal mass of a cartridge heater, the additional radiation heat loss, and the limitation on power density (heat flux) when the heater is so distanced from the target. Furthermore, a cartridge heater requires a high precision intermediate thermal conducting layer to improve the contact between the heater and the component. This additional layer (often made of a precious metal) adds significant cost and labor to the pump.

As another example, a DNA analyzer contains a cup holder, which holds plastic cups containing liquids for enzyme reactions to proceed. This cup holder must be heated from extremely low temperatures, and is typically heated using a silicone rubber heated (etched foil type) bonded to the cup holder with an adhesive. The bonding process is very labor intensive and often results in the production of gas bubbles in the adhesive layer. These gas bubbles are poor heat conductors and therefore create zones of localized overheating and uneven temperature distribution overall. These zones also result in delamination of the heater (because of the different zones of thermal expansion) and in many situations, heater failure. The silicone rubber heater suffers from power density limitations that usually limit the heater to 20 W/m² (3.1 W/cm²).

Many of the above limitations could be overcome, in theory, with the use of thick film heater technology. The thick film resistive circuit could be printed directly on the target object. Unfortunately, thick film heating circuits made of silicone based inks crack after several cycles at such extremely low temperatures, rendering them useless. It is also known to use other polymer-based thick film inks (e.g. epoxy based), but when used at low temperatures, these circuits display gradual changes in resistance with heat cycling. The change in resistance naturally means a change in power density of the heater (assuming constant voltage) which is unacceptable in these applications.

It is thus an object of the present invention to provide a thick film heater integrated with a target object to be heater.

It is a further object of the present invention to provide a thick film heater that can withstand operation in extremely cold ambient temperatures.

It is yet another object of the present invention to provide a novel method or preparing such a thick film heating circuit.

Other objects of the invention will become apparent from the description of the invention, below.

### SUMMARY OF INVENTION

In keeping with the above-identified objects, the present invention is a thick film heater integrated with the target object to be heated. The integration is effected by the direct application of the thick film resistive circuit to a surface of the target object.

According to one aspect of the present invention an epoxy-based ink is used to form the thick film resistive circuit, as it is less prone to chipping during the cooling cycle than glass-based inks. Not only is the epoxy-based ink less expensive than glass-based inks, but the technology has not yet been developed to allow glass-based ink dielectrics to be directly applied to aluminum or copper substrates. The ink is typically an epoxy binding with a electrically conductive particles dispersed throughout the binding.

According to another aspect of the present invention, the thick film resistive circuit undergoes multiple curing cycles. While, it is typical to follow the manufacturer's directions for curing the thick film inks, such directions call for a single curing cycle, which as discussed above, results in a circuit prone to resistance fluctuations.

The circuit of the present invention is first cured according to the manufacturer's directions. It is then cured at least one other time at typically higher temperatures for longer cycles.

According to yet another aspect of the present invention, a dielectric layer is disposed over the thick film resistive circuit to protect the circuit from being shorted by foreign objects. The dielectric layer also provides mechanical protection to the circuit. If part of the circuit is chipped away or scratched the resistance of the circuit at that location will increase, which is unacceptable for the types of applications in which the present invention is utilized.

It may also be preferable (and perhaps even necessary) depending on the surface material of the target object to include a dielectric layer below the thick film resistive circuit as well. For instance, if the target object is made of a good electrical conductor, such as a steel, a lower dielectric layer will obviously be needed to prevent shorting.

The means for depositing the thick film resistive circuit on the target object do not differ from the conventional means for creating thick film heaters, and as such are well known to those skilled in the art of designing thick film heaters. For example, thick film heaters are discussed in U.S. Pat. Nos. 6,037,574; 5,973,296; and 6,222,166, all of which having a common assignee herewith and all of which are incorporated herein by reference.

The key differences from conventional prior art heaters, which allows the present invention to fulfill the objectives stated herein, are the careful selection of a polymer-based conductive ink and the development of a multi-stage cure cycle to ensure a stable resistance during actual use.

The resulting heater is a thick film resistive circuit applied directly to a target object. It works in very low temperatures with great reliability and with power densities (heat fluxes) of up to 200 watts per square inch (31 W/cm²).

### BRIEF DESCRIPTION OF DRAWINGS

The above-mentioned and other features, advantages, and objects of this invention, and the manner in which they are obtained, will become more apparent and will be best understood by reference to the detailed description in conjunction with the accompanying drawings which follow, wherein:

FIG. 1 is a graph demonstrating the stability of resistance in the heating element of one embodiment of the present invention;

FIG. 2 is a graph comparing resistance change in the heating element of a another embodiment of the present invention with that of a heating element in a more conventional thick film heater; and

FIG. 3 is a graph illustrating the increasing benefits of the present invention as power density (heat flux) increases.

### DETAILED DESCRIPTION

The present invention is made primarily by applying a heating element of a thick film resistive circuit directly to a target object or optionally over a dielectric layer applied directly to the target object. For the sake of simplicity, the phrase “directly to a target object” means either in direct contact with the target object or in direct contact with a thick film (or thinner) dielectric layer, which, in turn, is in direct contact with the target object.

The application of the heating element to the target object, as well as the application of any dielectric layers below or above the heating element is performed using any of a wide variety of conventional thick film technologies, such as screen printing, all of which are well known in the art. Two aspects of the present invention in tandem distinguish it from the prior art and allow it to achieve the stated objectives.

The first such aspect is the use of specific polymer-based inks for the thick film circuit, such as an epoxy-based ink. Although other conductive polymer-based inks may perform adequately for this invention, certain polymer-based inks have shown particularly advantageous properties for direct application to a low-temperature target object. Ceramic-based inks will also work with this invention in some applications, but are not preferred due to their higher costs and the inability to use them on non-ferrous metal substrates. Such preferred polymer-based inks include epoxy-based inks from Hereaus Company of West Conshohock, Pa. and Electro Science Laboratories, Inc. of King of Prussia, Pa.

At the time of the present application, the best known ink for the present invention is the T2100 ink (epoxy base with silver conductive particles) on a dielectric layer of PD5200 ink (epoxy base).

In low temperature applications, the bindings of silicone-based inks have become brittle during the cooling cycle and chip at the edges. Such chipping produces resistance changes in the circuit, and could even lead to complete heater failure prematurely.

The second differentiating aspect is the use of additional curing cycles or a single curing cycle at a higher temperature and/or longer duration than conventionally used. The typical directions from the manufacturer for curing the polymer-based inks in a thick resistive circuit involve baking the ink at a temperature of 150° C. for thirty minutes. It has been discovered that such curing cycles do not produce circuits with stable resistance. While a circuit cured according to the normal process, as recommended by the ink manufacturer, might have an initial resistance of 40 Ω for example, after several thousand heating cycles the resistance will be permanently reduced. After as many as 10,000 such cycles, the resistance may be less than 20 Ω—half of the original resistance. Such permanent changes may not take place in the typical thick film application involving a low power density circuit where the temperature change during a single cycle is not dramatic. This is a major reason why thick film circuits are not common place in high power density applications.

By way of example, a target object of nickel-plated copper was prepared with a dielectric paste. The dielectric paste consisted of TiO₂ particle filler and cobalt oxide pigment in a polymer-based (epoxy) binding agent. Thinner and thioxtropic forming agent were added to the dielectric to make it suitable for deposition using commonly known silk screening techniques. The dielectric layer was set in an electric oven at temperatures between 50° C. and 150° C. for a period of sixty minutes.

Thereafter a thick film resistive circuit was silk screen printed over the dielectric layer. The resistive ink was a mixture of silver conducting particles in a polymer-based (epoxy) binding agent. Again, thinner and thioxtropic forming agent were added to thin ink to allow for screen printing. The resistive circuit was cured according to manufacturer's specifications—150° C. for thirty minutes. An outer dielectric layer identical to the initial dielectric layer was added over the resistive circuit. The entire heater (target object, dielectric layers, and resistive circuit) was cured for another cycle of 150° C. for sixty minutes.

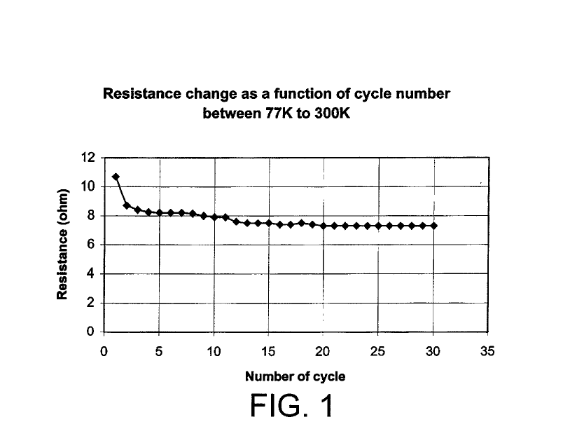

The resulting heater was capable of functioning at very low temperatures without chipping or cracking. After thirty-five immersions in liquid nitrogen (temperature: 77K) from room temperature the heating element showed no cracking or delamination. The resistance of this heater was also stable after fifty such cycles as illustrated in FIG. 1. While the low temperature stability of the resistance was excellent, cycling the heating element between 40° C. and 125° C. resulted in a constant decrease in resistance. After 7,000 such heating cycles, the resistance of the circuit had decreased approximately 50%.

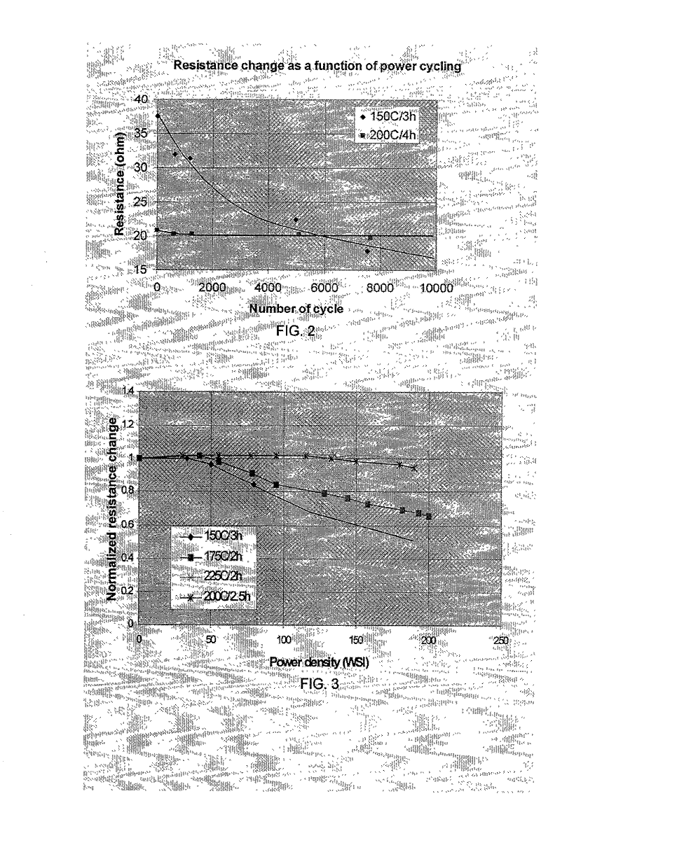

It has been discovered that a post curing cycle of 200° C. for a longer period of time results in more resistance stability at the higher temperature cycling (40° C. 1250° C.). FIG. 2 shows the comparative change in resistance over approximately 8,000 such cycles for two heaters prepared as above, but post-cured for three hours at 150° C. and four hours at 200° C. The heaters were designed for 100 watts per square inch, but this technology can be used at power densities up to 200 watts per square inch.

The improved stability of the higher temperature post-cure treatments is more pronounced at high power densities. FIG. 3 shows the normalized resistance change for four heaters prepared as above but with differing post-cure treatments. As can be seen, at higher power densities the contrast in resistance stability for the four heaters is surprisingly stark. The reason for this dramatic difference is not known, however empirical evidence clearly shows the difference is real. It can also be seen in FIG. 3 that higher temperature in the post-cure treatment are more important than longer treatment times. For instance the resistance stability of a post-cure treatment at 150° C. for three hours was dramatically worse than post-cure treatments at 225° C. for two hours or 200° C. for 2.5 hours.

As mentioned previously, any number of conventional methods may be used to deposit the circuit (or dielectric layers) on the target object. For example, syringe deposition may be used on target objects that are unsuitable for screen printing, such as those with curved geometries. Spraying techniques are also appropriate for use with the present invention.

The heater must of course be terminated, which can also be done with a wide variety of known techniques. On appropriate example involves the use of silver coated copper lead wires applied onto a terminal pad using the same ink as used for the thick film circuit. This is followed by a standard cure treatment (150° C. for thirty minutes). Any number of standard terminating methods may also be used without departing from the scope of the invention.

Accordingly, while this invention is described with reference to a preferred embodiment of the invention, it is not intended to be construed in a limiting sense. It is rather intended to cover any variations, uses or adaptations in the invention utilizing its general principles. Various modifications will be apparent to persons skilled in the art upon reference to this description. it is therefore contemplated that the appended, and any claims will cover any such modifications or embodiments as fall within the true scope of the invention.

1. A thick film heater comprising
a target object to be heated, wherein said target object is located in an environment of ambient temperatures significantly below 0° C.;
a heating element consisting of an electrically thick film resistive circuit applied directly to a surface of said target object; and
wherein said electrically thick film resistive circuit is polymer based.

2. The thick film heater of claim 1 wherein said target object is designed to operate at temperatures below −75° C.

3. The thick film heater of claim 2 wherein said target object is designed to operate at temperatures below −150° C.

4. The thick film heater of claim 1 wherein said heating element is capable of heat flux at least as great as 200 watts per square inch.

5. The thick film heater of claim 1 wherein said target object is non-ferrous.

6. The thick film heater of claim 5 wherein said target object is aluminum.

7. The thick film heater of claim 5 wherein said target object is copper.

8. The thick film heater of claim 5 wherein said target object is ceramic.

9. The thick film heater of claim 1 wherein said target object is a high-expansion steel.

10. The thick film heater of claim 1 wherein said heating element further comprises a dielectric layer disposed between said target object and said electrically resistive circuit.

11. The thick film heater of claim 10 wherein said heating element further comprises a second dielectric layer disposed over said electrically resistive circuit, away from said target object.

12. The thick film heater of claim 10 wherein said dielectric layer consists of a metal oxide.

13. The thick film heater of claim 12 wherein said metal oxide is selected from the group consisting of TiO2, SiO2, and Al2O3.

14. A method of manufacturing a thick film heater comprising a heating element applied directly to a surface of a target object, the method comprising the steps of:
applying the heating element, comprising a thick film resistive circuit directly to the surface of the target object, wherein the thick film resistive circuit is made of a polymer-based ink;
curing the heating element at a temperature in excess of 150° C. for a period of time in excess of thirty minutes; and
sealing the heating element with a dielectric layer.

15. The method of claim 14 further comprising a plurality of said curing steps, wherein at least one of said curing steps occurs at a temperature in excess of 150° C. for a period of time in excess of thirty minutes.

16. The method of claim 14 further comprising the step of preparing the surface of the target object with a lower dielectric layer, and wherein the heating element in said applying layer is applied over the lower dielectric layer.

17. The method of claim 14 wherein said curing step occurs at a temperature of 200° C. or greater.

18. The method of claim 14 wherein said curing step occurs for a period of two hours or longer.

19. The method of claim 14 wherein the heating element is designed to operate at greater than 15 W/cm².

20. The method of claim 14 wherein the target object is non-ferrous.

21. The method of claim 20 wherein the target object is aluminum.

22. The method of claim 19 wherein the target object is copper.

23. The method of claim 20 wherein the target object is ceramic.

24. The method of claim 13 wherein the target object is high-expansion steel.

25. The method of claim 13 wherein the polymer base of the thick film resistive circuit is an epoxy.

26. The method of claim 24 wherein the polymer-based ink contains silver particles.
